(19) United States
(12) Patent Application Publication
(10) Pub. No.: US 2026/0175528 A1
(43) Pub. Date: Jun. 25, 2026

(54) PIGMENT ENCAPSULATION LAYER FOR CONTACT LENSES

(71) Applicant: Alcon Inc., Fribourg (CH)

(72) Inventors: Richard Charles Breitkopf, Dunwoody, GA (US); Feng Jing, Alpharetta, GA (US); Daqing Wu, Suwanee, GA (US); Jack W. Trieu, Atlanta, GA (US); Steve Yun Zhang, Sugar Hill, GA (US)

(21) Appl. No.: 19/428,604

(22) Filed: Dec. 22, 2025

Related U.S. Application Data
(60) Provisional application No. 63/738,221, filed on Dec. 23, 2024.

(51) Int. Cl. B29D 11/00; G02B 1/04; G02C 7/04

(52) U.S. Cl. CPC B29D 11/00326; B29D 11/00134; B29D 11/00923; G02B 1/043; G02C 7/046

(57) ABSTRACT

In general, embodiments of the present disclosure relate to pigment containing contact lenses, such as colored contact lenses. In particular, embodiments of the present disclosure relate to a silicon hydrogel (SiHy) contact lens having a layered configuration that completely encapsulates a layer of pigment. In at least some embodiments, a method for forming a contact lens is provided. The method includes applying a clear ink to at least an iris portion of a mold and curing the clear ink with UV light to form a clear ink layer. The clear ink includes about 38 wt % to about 70 wt % of a polymer binder. The method further includes, applying, via pad printing, at least one pigmented layer onto the cured clear ink layer, and curing the at least one pigmented layer with UV light to form a lens assembly.

### INTRODUCTION

Aspects of the present disclosure relate to the field of vision correction and, more specifically, to pigment containing contact lenses having a layered configuration.

### BACKGROUND

Silicone hydrogel (SiHy) contact lenses are widely used for correcting many different types of vision deficiencies. The contact lenses are made of a hydrated, crosslinked polymeric material that contains silicone and a certain amount of water within the lens polymer matrix at equilibrium. According to the FDA's contact lens classification, hydrogel contact lenses are generally classified into two main categories: low water content contact lenses (containing less than 50% of water) and high water content contact lenses (containing greater than 50% of water). For SiHy contact lenses, high oxygen permeability, which is desired for a contact lens to have minimal adverse effects upon corneal health, is achieved by incorporating silicone, not by increasing water content, in the crosslinked polymeric material. As a result, unlike conventional hydrogel contact lenses, SiHy contact lenses can have a low water content while still having a relatively high oxygen permeability (Dk).

Water in a SiHy contact lens can provide the desirable softness that enables a SiHy lens to be worn for sufficiently long periods of time and provides patients with the benefits including adequate initial comfort (i.e., immediately after lens insertion), relatively short period of time for a patient to become accustomed to the contact lens, and/or proper fit. Higher water content would be desirable for providing SiHy contact lenses with biocompatibility and comfort.

In addition, SiHy contact lenses are frequently utilized for cosmetic effect. For example, wearing a colored contact lens on the eye is utilized in an effort to alter the apparent color of the wearer's iris. Colorants such as dyes or pigments of a desired color or colors are applied to a contact lens in a pattern adapted to overlie the natural iris, thereby altering the natural iris color. Such contact lenses may provide vision correction, or may be solely cosmetic. However, the colorants may bleed or diffuse through the bulk material of the contact lens, blurring the pattern and potentially causing discomfort to the wearer due to pigment abrasions on the cornea and the inner eyelid.

Accordingly, there is a need for improved techniques for forming pigment-containing contact lenses.

### BRIEF SUMMARY

Embodiments described herein generally relate to pigment-containing contact lenses, such as colored contact lenses. In particular, embodiments of the present disclosure relate to a silicon hydrogel contact lenses having a layered configuration.

Some embodiments provide a method for forming a contact lens. The method includes applying a clear ink to at least an iris portion of a mold and curing the clear ink with UV light to form a clear ink layer. The clear ink includes about 38 wt % to about 70 wt % of a polymer binder. The method further includes, applying, via pad printing, at least one pigmented layer onto the clear ink layer, and curing the at least one pigmented layer with UV light to form a lens assembly.

Some embodiments provide a method for forming a contact lens. The method includes applying a clear ink to at least an iris portion of a mold and curing the clear ink with UV light to form a clear ink layer. The method further includes, applying, via pad printing, at least one pigmented layer onto the cured clear ink layer, curing the at least one pigmented layer with UV light to form a lens assembly, and heat treating the lens assembly.

Some embodiments provide a contact lens. The contact lens includes a clear ink layer having a thickness of about 5 μm to about 20 μm and including about 38 wt % to about 70 wt % of polymer binder units and about 1 wt % to about 5 wt % of acid-group containing units. The clear ink layer forms an iris portion of the contact lens. The contact lens further includes, at least one pigmented layer disposed on the clear ink layer, the at least one pigmented layer including an iris pattern, and a lens body disposed over the at least one pigmented layer, the lens body including a silicone hydrogel.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 depicts a peripheral view of a SiHy contact lens having a layered configuration, in accordance with some embodiments described herein.

FIG. 2 depicts a frontal view of a SiHy contact lens having a layered configuration, in accordance with some embodiments described herein.

FIG. 3 depicts an exploded view of a SiHy contact lens having a layered configuration, in accordance with some embodiments described herein.

FIG. 4 is a flow diagram depicting a method for forming a SiHy contact lens having a layered configuration, in accordance with some embodiments described herein.

FIGS. 5A-B each depict cross sections of SiHy contact lenses formed with various concentrations of solid polymer binder, in accordance with some embodiments described herein.

FIG. 6 depicts cross sections of SiHy contact lenses formed with and without UV curing, in accordance with some embodiments described herein.

FIG. 7 depicts cross sections of SiHy contact lenses formed with and without a heat treatment, in accordance with some embodiments described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

In general, embodiments of the present disclosure relate to pigment-containing contact lenses, such as colored contact lenses. For example, embodiments of the present disclosure relate to a silicon hydrogel (SiHy) contact lens having a layered configuration that encapsulates a layer of pigment, preventing wearer discomfort by preventing pigment abrasions on the inner eyelid and cornea, and methods for forming the same. In at least some embodiments, a pigmented layer is disposed between a silicon hydrogel clear ink layer including about 38 wt % to about 70 wt % of polymer binder units, and a SiHy lens-forming material. In some embodiments, a method includes individually printing and UV curing a clear ink layer and a pigmented layer to form a lens assembly, and heat treating the lens assembly.

Reference will now be made in detail to the embodiments of the disclosure. It will be apparent to those skilled in the art that various modifications, variations and combinations can be made in the present disclosure without departing from the scope or spirit of the disclosure. For instance, features illustrated or described as part of one embodiment, can be used on another embodiment to yield a still further embodiment. Thus, it is intended that the present disclosure cover such modifications, variations and combinations as come within the scope of the appended claims and their equivalents. Other objects, features and aspects of the present disclosure are disclosed in or are obvious from the following detailed description. It is to be understood by one of ordinary skill in the art that the present discussion is a description of exemplary embodiments only, and is not intended as limiting the broader aspects of the present disclosure.

Unless defined otherwise, all technical and scientific terms used herein have the same meaning as commonly understood by one of ordinary skill in the art to which this disclosure belongs. Generally, the nomenclature used herein and the laboratory procedures are well known and commonly employed in the art. Conventional methods are used for these procedures, such as those provided in the art and various general references. Where a term is provided in the singular, the disclosure also contemplates the plural of that term. The nomenclature used herein and the laboratory procedures described below are those known and commonly employed in the art.

As used in this application, the term “silicone hydrogel contact lens” refers to a contact lens comprising a silicone hydrogel material.

As used in this application, the term “contact lens” refers to an object that can be placed on or within a wearer's eye. A contact lens can correct, improve, or alter a user's eyesight, but that need not be the case. A contact lens can be of any appropriate material known in the art or later developed, and can be a soft lens, a hard lens, or a hybrid lens. A contact lens can be tinted before printing any color patterns. A contact lens can be in a dry state or a wet state. “Dry State” refers to a soft lens in a state prior to hydration or the state of a hard lens under storage or use conditions. “Wet State” refers to a soft lens in a hydrated state.

The “front surface” or “anterior surface” of a contact lens, as used herein, refers to the surface of the lens that faces away from the eye during wear. The anterior surface, which is typically substantially convex, may also be referred to as the front curve of the lens.

The “rear or posterior surface” of a contact lens, as used herein, refers to the surface of the lens that faces towards the eye during wear. The rear surface, which is typically substantially concave, may also be referred to as the base curve of the lens.

As used in this application, the term “hydrogel” or “hydrogel material” refers to a crosslinked polymeric material which is not water-soluble and can contain at least 10% by weight of water within its polymer matrix when fully hydrated.

As used in this application, the term “silicone hydrogel refers to a hydrogel-containing silicone. A silicone hydrogel typically is obtained by copolymerization of a polymerizable composition comprising at least one silicone-containing vinylic monomer or at least one silicone-containing vinylic macromer or at least one silicone-containing prepolymer having ethylenically unsaturated groups.

As used in this application, the term “lens-forming material” refers to a polymerizable composition which can be cured (i.e., polymerized and/or crosslinked) thermally or actinically (e.g., by actinic radiation) to obtain a crosslinked polymer. Examples of actinic radiation are UV irradiation, ionized radiation (e.g., gamma ray or X-ray irradiation), microwave irradiation, and the like.

As used in this application, the term “vinylic monomer” refers to a compound that has one sole ethylenically unsaturated group and can be polymerized actinically or thermally.

As used in this application, the term “olefinically unsaturated group” or “ethylenically unsaturated group” is employed herein in a broad sense and is intended to encompass any groups containing at least one >C═C< group. Exemplary ethylenically unsaturated groups include (meth)acryloyl

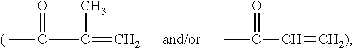

allyl, vinyl

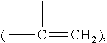

styrenyl, or other C═C containing groups.

As used in this application, the term “(meth)acrylamide” refers to methacrylamide and/or acrylamide.

As used in this application, the term “(meth)acrylate” refers to methacrylate and/or acrylate.

As used in this application, the term “hydrophilic vinylic monomer” refers to a vinylic monomer, which as a homopolymer typically yields a polymer that is water-soluble or can absorb at least 10 percent by weight water.

As used in this application, the term “hydrophobic vinylic monomer” refers to a vinylic monomer which as a homopolymer typically yields a polymer that is insoluble in water and can absorb less than 10 percent by weight water.

As used in this application, the term “macromer” or “prepolymer” refers to a medium and high molecular weight compound or polymer that contains two or more ethylenically unsaturated groups. Medium and high molecular weight typically means average molecular weights greater than 700 Daltons.

As used in this application, the term “crosslinker” refers to a compound having at least two ethylenically unsaturated groups. A “crosslinking agent” refers to a crosslinker having a molecular weight of about 700 Daltons or less.

As used in this application, the term “photoinitiator” refers to a chemical that initiates radical crosslinking/polymerizing reaction by the use of light. Suitable photoinitiators include benzoin methyl ether, diethoxyacetophenone, a benzoylphosphine oxide, 1-hydroxycyclohexyl phenyl ketone, Darocure® types, and Irgacure® types, such as Darocure® 1173, and Irgacure® 2959.

As used in this application, the term “thermal initiator” refers to a chemical that initiates radical crosslinking/polymerizing reaction by the use of heat energy. Examples of suitable thermal initiators include 2,2′-azobis(2,4-dimethylpentanenitrile), 2,2′-azobis(2-methylpropanenitrile), 2,2′azobis(2-methylbutanenitrle), peroxides such as benzoyl peroxide, and the like. For example, the thermal initiator is 2,2′-azobis(isobutyronitrile) (AIBN).

As used in this application, the term “polymer” means a material formed by polymerizing/crosslinking one or more monomers or macromers or prepolymers.

As used in this application, the term “molecular weight” of a polymeric material (including monomeric or macromeric materials) refers to the weight-average molecular weight unless otherwise specifically noted or unless testing conditions indicate otherwise.

As used in this application, the term “amino group” refers to a primary or secondary amino group of formula-NHR′, where R′ is hydrogen or a C₁-C₂₀ unsubstituted or substituted, linear or branched alkyl group, unless otherwise specifically noted.

As used in this application, the term “thermally-crosslinkable” in reference to a polymeric material or a functional group means that the polymeric material or the functional group can undergo a crosslinking (or coupling) reaction with another material or functional group at a relatively-elevated temperature (about 40° C. to about 140° C.), whereas the polymeric material or functional group cannot undergo the same crosslinking reaction (or coupling reaction) with another material or functional group at room temperature (about 22° C. to about 28° C., such as about 24° C. to about 26° C., in particular at about 25° C.) to an extent detectable (i.e., greater than about 5%) for a period of about one hour.

As used in this application, the term “reactive vinylic monomer” refers to a vinylic monomer having a carboxyl group or an amino group (e.g., a primary or secondary amino group).

As used in this application, the term “non-reactive hydrophilic vinylic monomer” refers to a hydrophilic vinylic monomer, which is free of any carboxyl group or amino group (e.g., primary or secondary amino group). A non-reactive vinylic monomer can include a tertiary or quaternium amino group.

As used in this application, the term “water-soluble” in reference to a polymer means that the polymer can be dissolved in water to an extent sufficient to form an aqueous solution of the polymer having a concentration of up to about 30% by weight at room temperature (defined above).

As used in this application, the term “water contact angle” refers to an average water contact angle (i.e., contact angles measured by Sessile Drop method), which is obtained by averaging measurements of contact angles.

As used in this application, the term “ophthalmically compatible” refers to a material or surface of a material which may be in intimate contact with the ocular environment for an extended period of time without significantly damaging the ocular environment and without significant user discomfort.

As used in this application, the term “ophthalmically safe” with respect to a packaging solution for sterilizing and storing contact lenses is intended to mean that a contact lens stored in the solution is safe for direct placement on the eye without rinsing after autoclave and that the solution is safe and sufficiently comfortable for daily contact with the eye via a contact lens. An ophthalmically-safe packaging solution after autoclave has a tonicity and a pH that are compatible with the eye and is substantially free of ocularly irritating or ocularly cytotoxic materials according to international ISO standards and U.S. FDA regulations.

As used in this application, the term “cross section” of a SiHy contact lens refers to a lens section obtained by cutting through the lens with a knife or cutting tool at an angle substantially normal to either of the anterior and posterior surfaces of the lens. A person skilled in the art knows well to cut manually (i.e., hand cut), or with Cryosta Microtome or with a lath, a contact lens to obtain a cross section of the contact lens. A resultant cross section of a contact lens can be polished by using ion etching or similar techniques.

As used in this application, the term “dye” means a substance that is soluble in a solvent and that is used to impart color. Dyes are typically transparent or translucent and absorb but do not scatter light. Dyes can cover both optical regions of contact lenses and non-optical regions of contact lenses.

As used in this application, the term “pigment” means a powdered substance that is suspended in a liquid in which it is insoluble. Pigments are used to impart color. Pigments, in general, are more opaque than dyes.

In general, embodiments of the present disclosure relate to pigment-containing contact lenses, such as colored contact lenses. For example, embodiments of the present disclosure relate to a SiHy contact lens having a layered configuration that encapsulates a layer of pigment, preventing wearer discomfort by preventing pigment abrasions on the eye or inner eyelid. In at least some embodiments, the clear ink used to print the outer most layer of the contact lens exhibits wettability.

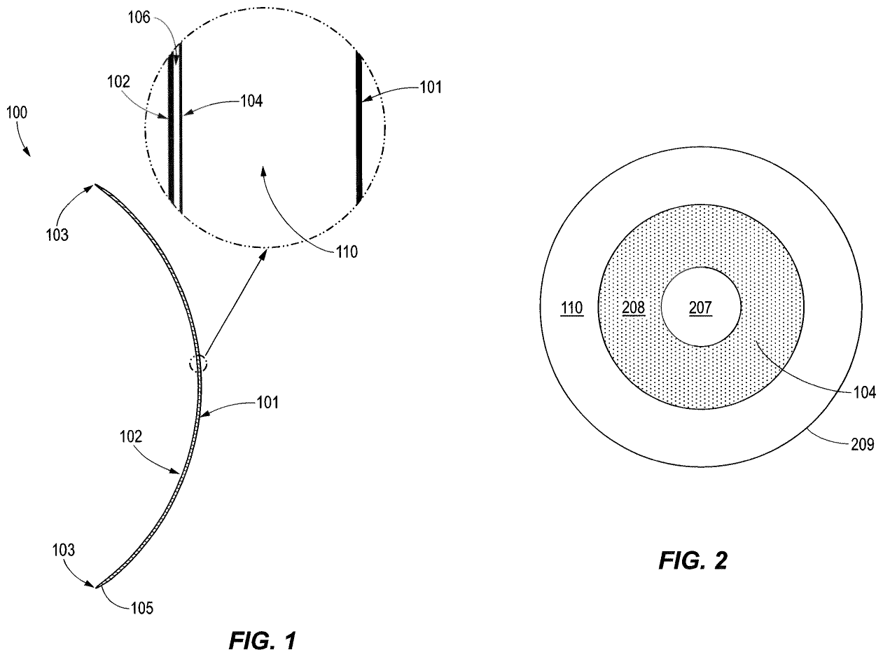

FIG. 1 depicts a SiHy contact lens having a layered configuration, according to some embodiments. In accordance with some embodiments, the SiHy contact lens 100 has an anterior surface (or front curve or convex surface) 101 and an opposite posterior surface (or base curve or concave surface) 102 which rests on the cornea of the eye when worn by a user. The SiHy contact lens 100 includes a lens-forming material 110, a pigmented layer 104, and a clear ink layer 106. The lens-forming material 110 is the bulk material of the SiHy contact lens 100 and has a 3-dimensional shape very close to the SiHy contact lens 100. In some embodiments, the lens-forming material 110 may include a silicone hydrogel. In some embodiments, the lens-forming material 110 and the clear ink layer 106 may include the same silicone hydrogel macromer. The pigmented layer 104 is disposed between the lens-forming material 110 and the clear ink layer 106. The clear ink layer 106 covers the pigmented layer 104 on the posterior surface of the SiHy contact lens 100, such that the clear ink layer 106 is on the inner surface of the SiHy contact lens 100 facing towards the eye of the wearer. The peripheral edge 103 of the clear ink layer 106 merges with the lens-forming material 110 at point 105 to completely cover and encapsulate the pigmented layer 104. Advantageously, the encapsulation of the pigmented layer 104 between the lens-forming material 110 and the clear ink layer 106 prevents pigment abrasions to the wearer's eye or inner eyelid.

FIG. 2 depicts a frontal view of a SiHy contact lens having a layered configuration, according to some embodiments. The SiHy contact lens 100 includes a pupil portion 207 and an iris portion 208 surrounding the pupil portion 207. The iris portion 208 is generally annular and is defined as the portion of the SiHy contact lens that, when worn, covers the wearer's iris or the colored portion of the eye. The pigmented layer 104 may be printed in at least an iris portion 208 of the SiHy contact lens 100 so as not to obstruct the pupil portion 207. In at least some embodiments, the pigmented layer 104 may extend past the iris portion toward the peripheral edge 209 of the SiHy contact lens 100, such that, when worn, the pigmented layer covers at least a portion of the wearer's sclera. In at least some embodiments, the pigmented layer 104 includes opaque pigments printed in a desired pattern. The pattern may be any suitable pattern for cosmetic or medical contact lenses. In at least one embodiment, examples of suitable patterns include an outer starburst pattern, an inner starburst patter, and a limbal ring. In some embodiments, the pigmented layer 104 includes multiple individually printed patterns layered on top of one another to form a more complex pattern. The pigmented layer 104 may include any number of individually printed pigmented layers having individual patterns, such as two or more, three or more, four or more, or five or more.

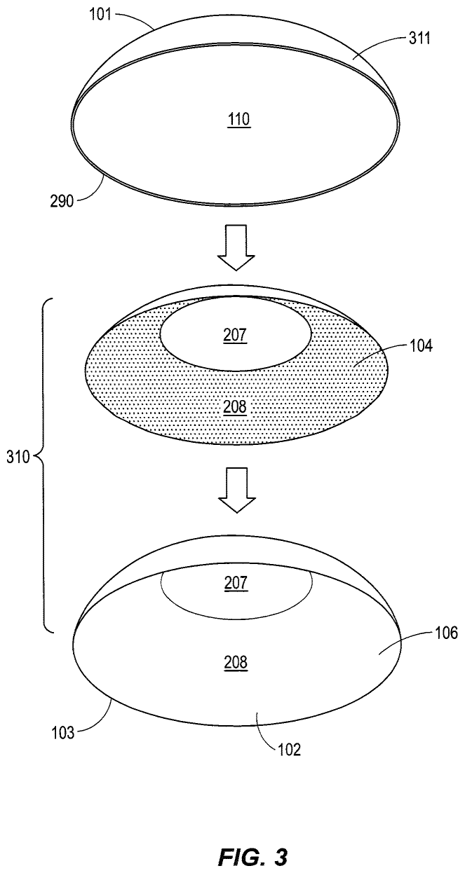

FIG. 3 depicts an exploded view of a SiHy contact lens having a layered configuration, according to some embodiments. In some embodiments, the clear ink layer 106 is an annular layer disposed in at least the iris portion 208 of the SiHy contact lens 100 surrounding the pupil portion 207. In other embodiments, the clear ink layer 106 may extend past the iris section to the peripheral edge 209 of the SiHy contact lens 100. In at least one embodiment, the clear ink layer at least partially covers to pupil portion 207 of the SiHy contact lens 100. The lens assembly 310 of the SiHy contact lens 100 includes the pigmented layer 104 disposed over the anterior surface of the clear ink layer 106. In at least some embodiments, the clear ink layer traps the pigmented layer 104, preventing the pigmented layer 104 from defusing towards or otherwise contacting the eye of the wearer. The lens-forming material 110 is disposed over the pigmented layer 104 and forms the lens body 311 including the anterior surface 101, which faces away from the eye when worn by a user.

In at least some embodiments, the clear ink layer 106 includes a percent of solid polymer that, when cured using the methods disclosed herein, advantageously prevents the pigmented layer 104 from diffusing into the clear ink layer 106, towards the eye, and into the lens-forming material 110, away from the eye, resulting in a sharper (less diffuse) pattern. The complete encapsulation of the pigmented layer 104 prevents pigment abrasions on the eye or inner eyelid, leading to a more comfortable SiHy contact lens 100. In at least some embodiments, the clear ink layer includes an acid group containing unit that increases the wettability of the clear ink layer 106, resulting in a more comfortable SiHy contact lens 100.

In some embodiments, which can be combined with other embodiments, the clear ink layer 106 includes a solid polymer. The solid polymer is a cured (e.g. polymerized) polymer binder including polymer binder units. In at least some embodiments, the solid polymer is a cured silicone hydrogel macromer based polymer binder. In at least some embodiments, the clear ink layer includes about 38 wt % to about 70 wt % of the solid polymer, such as about 38 wt % to about 60 wt %, about 45 wt % to about 60 wt %, about 50 wt % to about 60 wt %, or about 50 wt % to about 55 wt %. In at least some embodiments, the clear ink layer includes an acid group containing unit. The clear ink layer 106 may include about 1 wt % to about 10 wt % of the acid group containing unit, such as about 1 wt % to about 7 wt %, about 1 wt % to about 5 wt %, or about 2 wt % to about 3 wt %. In at least some embodiments, the acidic group containing unit may be an in-package coating (IPC) reactive monomer and/or polymer. In at least some embodiments, the clear ink layer 106 may have a water contact angle of about 75° to about 120°, such as about 80° to about 110°, about 90° to about 110°, or about 90° to about 120°. In at least some embodiments, the clear ink layer 106 may have a surface wettability characterized by having an averaged water contact angle of about 90° or less, such as about 80° or less, about 70° or less, about 60° or less, or about 50° or less. In at least some embodiments, the water contact angle of the clear ink layer 106 may be reduced by including an acid group containing monomer unit. As a non-limiting example, in one embodiment, a clear ink layer 106 including 0 wt % of an acid group containing monomer unit had a water contact angle of about 100° to about 120°. In contrast, a clear ink layer 106 including about 3 wt % of an acid group containing monomer unit had a water contact angle of about 75° to about 80°. In some embodiments, the clear ink layer 106 may have a thickness of about 5 μm to about 20 μm, such as about 5 μm to about 15 μm, about 5 μm to about 10 μm, or about 5 μm to about 9 μm.

In at least one embodiment, the SiHy contact lens 100 includes a clear ink layer 106, at least one pigmented layer 104, and a lens body 311. The clear ink layer 106 has a thickness of about 5 μm to about 20 μm and includes about 38 wt % to about 70 wt % of polymer binder units and about 1 wt % to about 5 wt % of acid-group containing units. The clear ink layer 106 forms an iris portion of the contact lens. The at least one pigmented layer 104 is disposed on the clear ink layer 106. The at least one pigmented layer 104 includes an iris pattern. The lens body 311 is disposed over the at least one pigmented layer 104, the lens body 311 includes a silicone hydrogel.

In at least some embodiments, the clear ink layer 106 is formed by curing a clear ink. The clear ink may generally include at least one of a polymer binder, an acid group containing monomer and/or polymer, a free-radical initiator (photoinitiator or thermal initiator), a crosslinking agent, and a diluent (such as a solvent). In at least some embodiments the clear ink includes about 38 wt % to about 70 wt % of the polymer binder, such as about 38 wt % to about 60 wt %, about 45 wt % to about 60 wt %, about 50 wt % to about 60 wt %, or about 50 wt % to about 55 wt %. The clear ink may include about 1 wt % to about 10 wt % of the acid group containing monomer and/or polymer, such as about 1 wt % to about 7 wt %, about 1 wt % to about 5 wt %, or about 2 wt % to about 3 wt %. The clear ink may include about 0.05 wt % to about 4 wt % of the free-radical initiator, such as about 0.1 wt % to about 2 wt %. In at least some embodiments, the clear ink may include about 0.05 wt % to about 4 wt % of the crosslinking agent, such as about 0.1 wt % to about 2 wt %. In at least some embodiments, the remainder of the clear ink includes a diluent, such as a solvent.

In at least some embodiments, the polymer binder, which forms the solid polymer when cured, may be a copolymer including silicone-containing vinylic monomers or macromers. Examples of silicone-containing vinylic monomers include N-[tris(trimethylsiloxy)silylpropyl]-(meth)acrylamide, N-[tris(dimethylpropylsiloxy)-silylpropyl]-(meth)acrylamide, N-[tris(dimethylphenylsiloxy)silylpropyl](meth)acrylamide, N-[tris(dimethylethylsiloxy)silylpropyl](meth)acrylamide, N-(2-hydroxy-3-(3-(bis(trimethylsilyloxy)methylsilyl)propyloxy)propyl)-2-methyl acrylamide; N-(2-hydroxy-3-(3-(bis(trimethylsilyloxy)methylsilyl)propyloxy)propyl)acrylamide; N,N-bis[2-hydroxy-3-(3-(bis(trimethylsilyloxy)methylsilyl)propyloxy)propyl]-2-methyl acrylamide; N,N-bis[2-hydroxy-3-(3-(bis(trimethylsilyloxy)methylsilyl)propyloxy)propyl]acrylamide; N-(2-hydroxy-3-(3-(tris(trimethylsilyloxy)silyl)propyloxy)propyl)-2-methyl acrylamide; N-(2-hydroxy-3-(3-(tris(trimethylsilyloxy)silyl)propyloxy)propyl)acrylamide; N,N-bis[2-hydroxy-3-(3-(tris(trimethylsilyloxy)silyl)propyloxy)propyl]-2-methyl acrylamide; N,N-bis[2-hydroxy-3-(3-(tris(trimethylsilyloxy)silyl)propyloxy)propyl]acrylamide; N-[2-hydroxy-3-(3-(t-butyldimethylsilyl)propyloxy)propyl]-2-methyl acrylamide; N-[2-hydroxy-3-(3-(t-butyldimethylsilyl)propyloxy)propyl]acrylamide; N,N-bis[2-hydroxy-3-(3-(t-butyldimethylsilyl)propyloxy)propyl]-2-methyl acrylamide; N,N-bis[2-hydroxy-3-(3-(t-butyldimethylsilyl)propyloxy)propyl]acrylamide; 3-methacryloxy propylpentamethyldisiloxane, tris(trimethylsilyloxy)silylpropyl methacrylate (TRIS), (3-methacryloxy-2-hydroxypropyloxy)propylbis(trimethylsiloxy)methylsilane), (3-methacryloxy-2-hydroxypropyloxy)propyltris(trimethylsiloxy)silane, 3-methacryloxy-2-(2-hydroxyethoxy)-propyloxy)propylbis(trimethylsiloxy)methylsilane, N-2-methacryloxyethyl-O-(methyl-bistrimethylsiloxy-3-propyl)silylcarbamate, 3-(trimethylsilyl)propylvinyl carbonate, 3-(vinyloxycarbonylthio)propyl-tris(trimethyl-siloxy)silane, 3-[tris(trimethylsiloxy)silyl]propylvinyl carbamate, 3-[tris(trimethylsiloxy)silyl]propylallyl carbamate, 3-[tris(trimethylsiloxy)silyl]propyl vinyl carbonate, t-butyldimethyl-siloxyethyl vinyl carbonate; trimethylsilylethyl vinyl carbonate, and trimethylsilylmethylvinyl carbonate). Some example siloxane-containing (meth)acrylamide monomers are N-[tris(trimethylsiloxy)silylpropyl]acrylamide, TRIS, N-[2-hydroxy-3-(3-(tbutyldimethylsilyl)propyloxy)propyl]acrylamide, or combinations thereof.

A class of silicone-containing vinylic monomers or macromers is polysiloxane-containing vinylic monomers or macromers. Examples of such polysiloxane-containing vinylic monomers or macromers are monomethacrylated or monoacrylated polydimethylsiloxanes of various molecular weight (e.g., mono-3-methacryloxypropyl terminated, mono-butyl terminated polydimethylsiloxane or mono-(3-methacryloxy-2-hydroxypropyloxy)propyl terminated, mono-butyl terminated polydimethylsiloxane); dimethacrylated or diacrylated polydimethylsiloxanes of various molecular weight; vinyl carbonate-terminated polydimethylsiloxanes; vinyl carbamate-terminated polydimethylsiloxane; vinyl terminated polydimethylsiloxanes of various molecular weight; methacrylamide-terminated polydimethylsiloxanes; acrylamide-terminated polydimethylsiloxanes; acrylate-terminated polydimethylsiloxanes; methacrylate terminated polydimethylsiloxanes; bis-3-methacryloxy-2-hydroxypropyloxypropyl polydimethylsiloxane; N,N,N′,N′tetrakis(3-methacryloxy-2-hydroxypropyl)-alpha,omegabis-3-aminopropyl-polydimethylsiloxane; polysiloxanylalkyl(meth)acrylic monomers; siloxane-containing macromer selected from Macromer A, Macromer B, Macromer C, and Macromer D described in U.S. Pat. No. 5,760,100 (herein incorporated by reference in its entirety); the reaction products of glycidyl methacrylate with amino-functional polydimethylsiloxanes; hydroxyl-functionalized siloxane-containing vinylic monomers or macromers; polysiloxane-containing macromers; polysiloxane-containing macromers. Di and triblock macromers such as polydimethylsiloxane and polyalkyleneoxides could also be of utility. For example, one might use methacrylate end capped polyethyleneoxide-block-polydimethylsiloxane-block-polyethyleneoxide to enhance oxygen permeability. Suitable monofunctional hydroxyl-functionalized siloxane-containing vinylic monomers/macromers and suitable multifunctional hydroxylfunctionalized siloxane-containing vinylic monomers/macromers are commercially available from Gelest, Inc, Morrisville, Pa. In at least one embodiment, the polymer binder is a lotrafilcon B macromer. In at least one embodiment, the polymer binder is a betacon macromer. In at least some embodiments, a betacon macromer is a dimethacrylate-terminated chain-extended polydimethylsiloxane, which has two polydimethylsiloxane (PDMS) segments separated by one perfluoropolyether (PFPE) via diurethane linkages between PDMS and PFPE segments and two urethane linkages each located between one terminal methacrylate group and one PDMS segment.

In at least some embodiments, the acid group containing monomer and/or polymer may include acrylic acid, polyacrylic acid, C₁-C₁₂ alkylacrylic acid (e.g., methacrylic acid, ethylacrylic acid, propylacrylic acid, butylacrylic acid, pentylacrylic acid, etc.), N,N-2-acrylamidoglycolic acid, beta methyl-acrylic acid (crotonic acid), alpha-phenyl acrylic acid, beta-acryloxy propionic acid, sorbic acid, angelic acid, cinnamic acid, 1-carboxy-4-phenyl butadiene-1,3, itaconic acid, citraconic acid, mesaconic acid, glutaconic acid, aconitic acid, maleic acid, fumaric acid, tricarboxy ethylene, and combinations thereof.

In at least one embodiment, the clear ink includes a betacon macromer, N,N-dimethylacrylamide (DMA), a photoinitiator, such as Irgacure 2959®, and ethanol. The clear ink may include about 20 wt % to about 30 wt % of a betacon macromer, about 20 wt % to about 30 wt % of DMA, and about 0.1 wt % to about 2 wt % of Irgacure 2959®. The clear ink is cured using the methods disclosed herein to form the clear ink layer 106. The resultant clear ink layer 106 may include about 20 wt % to about 30 wt % of betacon macromer units and about 20 wt % to about 30 wt % of DMA units.

In at least some embodiments, the pigmented layer 104 is printed using a UV curable pigmented ink. The pigmented ink used to print the pigmented layer 104 may generally include at least one of a polymer binder, a pigment, a free-radical initiator (photoinitiator or thermal initiator), and a diluent (such as a solvent). In at least some embodiments, the pigmented ink may include about 5 wt % to about 20 wt % of a pigment, such as about 5 wt % to about 18 wt %, about 5 wt % to about 15 wt %, about 5 wt % to about 10 wt %, or about 10 wt % to about 20 wt %. The pigmented ink may include about 30 wt % to about 40 wt % of a polymer binder, such as about 30 wt % to about 38 wt %, about 30 wt % to about 35 wt %, or about 35 wt % to about 40 wt %. The pigmented ink may include about 1 wt % to about 4 wt % of a photoinitiator, such as about 1 wt % to about 3 wt %, about 1 wt % to about 2 wt %, or about 2 wt % to about 4 wt %. A diluent or solvent may make up the remainder of the pigmented ink. In at least some embodiments, the pigmented ink may include about 40 wt % to about 65 wt % of a solvent, such as about 40 wt % to about 60 wt %, about 40 wt % to about 55 wt %, about 40 wt % to about 50 wt %, or about 40 wt % to about 45 wt %.

In accordance with the disclosure, the lens-forming material 110 of the SiHy contact lens 100 may be referred to as the bulk material or bulk layer of the lens. In at least some embodiments, a SiHy lens formulation for the lens-forming material 110 generally includes at least one component selected from a silicone-containing vinylic monomer, a silicone-containing vinylic macromer, a silicone-containing prepolymer, a hydrophilic vinylic monomer, a hydrophobic vinylic monomer, a crosslinking agent (a compound having a molecular weight of about 700 Dal tons or less and containing at least two ethylenically unsaturated groups), a free-radical initiator (photoinitiator or thermal initiator), a hydrophilic vinylic macromer/prepolymer, and combination thereof, as well known to a person skilled in the art. A SiHy contact lens formulation can also include other necessary components known to a person skilled in the art, such as, for example, a UV-absorbing agent, a visibility tinting agent (e.g., dyes, pigments, or mixtures thereof), antimicrobial agents (e.g., silver nanoparticles), a bioactive agent, leachable lubricants, leachable tear-stabilizing agents, and mixtures thereof, as known to a person skilled in the art.

Any suitable silicone-containing vinylic monomers may be used in formulating the lens-forming material 110. Examples of silicone-containing vinylic monomers include N-[tris(trimethylsiloxy)silylpropyl]-(meth)acrylamide, N-[tris(dimethylpropylsiloxy)-silylpropyl]-(meth)acrylamide, N-[tris(dimethylphenylsiloxy)silylpropyl](meth)acrylamide, N-[tris(dimethylethylsiloxy)silylpropyl](meth)acrylamide, N-(2-hydroxy-3-(3-(bis(trimethylsilyloxy)methylsilyl)propyloxy)propyl)-2-methyl acrylamide; N-(2-hydroxy-3-(3-(bis(trimethylsilyloxy)methylsilyl)propyloxy)propyl)acrylamide; N,N-bis[2-hydroxy-3-(3-(bis(trimethylsilyloxy)methylsilyl)propyloxy)propyl]-2-methyl acrylamide; N,N-bis[2-hydroxy-3-(3-(bis(trimethylsilyloxy)methylsilyl)propyloxy)propyl]acrylamide; N-(2-hydroxy-3-(3-(tris(trimethylsilyloxy)silyl)propyloxy)propyl)-2-methyl acrylamide; N-(2-hydroxy-3-(3-(tris(trimethylsilyloxy)silyl)propyloxy)propyl)acrylamide; N,N-bis[2-hydroxy-3-(3-(tris(trimethylsilyloxy)silyl)propyloxy)propyl]-2-methyl acrylamide; N,N-bis[2-hydroxy-3-(3-(tris(trimethylsilyloxy)silyl)propyloxy)propyl]acrylamide; N-[2-hydroxy-3-(3-(t-butyldimethylsilyl)propyloxy)propyl]-2-methyl acrylamide; N-[2-hydroxy-3-(3-(t-butyldimethylsilyl)propyloxy)propyl]acrylamide; N,N-bis[2-hydroxy-3-(3-(t-butyldimethylsilyl)propyloxy)propyl]-2-methyl acrylamide; N,N-bis[2-hydroxy-3-(3-(t-butyldimethylsilyl)propyloxy)propyl]acrylamide; 3-methacryloxy propylpentamethyldisiloxane, tris(trimethylsilyloxy)silylpropyl methacrylate (TRIS), (3-methacryloxy-2-hydroxypropyloxy)propylbis(trimethylsiloxy)methylsilane), (3-methacryloxy-2-hydroxypropyloxy)propyltris(trimethylsiloxy)silane, 3-methacryloxy-2-(2-hydroxyethoxy)-propyloxy)propylbis(trimethylsiloxy)methylsilane, N-2-methacryloxyethyl-O-(methyl-bistrimethylsiloxy-3-propyl)silylcarbamate, 3-(trimethylsilyl)propylvinyl carbonate, 3-(vinyloxycarbonylthio)propyl-tris(trimethyl-siloxy)silane, 3-[tris(trimethylsiloxy)silyl]propylvinyl carbamate, 3-[tris(trimethylsiloxy)silyl]propylallyl carbamate, 3-[tris(trimethylsiloxy)silyl]propyl vinyl carbonate, t-butyldimethyl-siloxyethyl vinyl carbonate; trimethylsilylethyl vinyl carbonate, and trimethylsilylmethylvinyl carbonate). Some example siloxane-containing (meth)acrylamide monomers are N-[tris(trimethylsiloxy)silylpropyl]acrylamide, TRIS, N-[2-hydroxy-3-(3-(tbutyldimethylsilyl)propyloxy)propyl]acrylamide, or combinations thereof.

A class of silicone-containing vinylic monomers or macromers is polysiloxane-containing vinylic monomers or macromers. Examples of such polysiloxane-containing vinylic monomers or macromers are monomethacrylated or monoacrylated polydimethylsiloxanes of various molecular weight (e.g., mono-3-methacryloxypropyl terminated, mono-butyl terminated polydimethylsiloxane or mono-(3-methacryloxy-2-hydroxypropyloxy)propyl terminated, mono-butyl terminated polydimethylsiloxane); dimethacrylated or diacrylated polydimethylsiloxanes of various molecular weight; vinyl carbonate-terminated polydimethylsiloxanes; vinyl carbamate-terminated polydimethylsiloxane; vinyl terminated polydimethylsiloxanes of various molecular weight; methacrylamide-terminated polydimethylsiloxanes; acrylamide-terminated polydimethylsiloxanes; acrylate-terminated polydimethylsiloxanes; methacrylateterminated polydimethylsiloxanes; bis-3-methacryloxy-2-hydroxypropyloxypropyl polydimethylsiloxane; N,N,N′,N′tetrakis(3-methacryloxy-2-hydroxypropyl)-alpha,omegabis-3-aminopropyl-polydimethylsiloxane; polysiloxanylalkyl(meth)acrylic monomers; siloxane-containing macromer selected from Macromer A, Macromer B, Macromer C, and Macromer D described in U.S. Pat. No. 5,760,100 (herein incorporated by reference in its entirety); the reaction products of glycidyl methacrylate with amino-functional polydimethylsiloxanes; hydroxyl-functionalized siloxane-containing vinylic monomers or macromers; polysiloxane-containing macromers; polysiloxane-containing macromers. Di and triblock macromers such as polydimethylsiloxane and polyalkyleneoxides could also be of utility. For example, one might use methacrylate end capped polyethyleneoxide-block-polydimethylsiloxane-block-polyethyleneoxide to enhance oxygen permeability. Suitable monofunctional hydroxyl-functionalized siloxane-containing vinylic monomers/macromers and suitable multifunctional hydroxylfunctionalized siloxane-containing vinylic monomers/macromers are commercially available from Gelest, Inc, Morrisville, Pa.

Another class of silicone-containing macromers is silicon-containing prepolymers comprising hydrophilic segments and hydrophobic segments. Any suitable of silicone-containing prepolymers with hydrophilic segments and hydrophobic segments may be used.

Examples of hydrophilic vinylic monomers are N,N-dimethylacrylamide (DMA), N,N-dimethylmethacrylamide (DMMA), 2-acrylamidoglycolic acid, 3-acryloylamino-1-propanol, N-hydroxyethyl acrylamide, N-[tris(hydroxymethy 1)methyl]-acrylamide, N-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methyl-ene-2-pyrrolidone, 1-n-propyl-5-methy lene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, 2-hydroxyethyl methacrylate (HEMA), 2-hydroxyethyl acrylate (HEA), hydroxypropyl acrylate, hydroxypropyl methacrylate (HPMA), trimethylammonium 2-hydroxy propylmethacrylate hydrochloride, aminopropyl methacrylate hydrochloride, dimethylaminoethyl methacrylate (DMAEMA), glycerol methacrylate (GMA), N-vinyl-2-pyrrolidone (NVP), allyl alcohol, vinylpyridine, a C₁-C₄-alkoxy polyethylene glycol(meth)acrylate having a weight average molecular weight of up to 1500, methacrylic acid, N-vinyl formamide, N-vinyl acetamide, N-vinyl isopropylamide, N-vinyl-N-methyl acetamide, allyl alcohol, N-vinyl caprolactam, and mixtures thereof.

Examples of hydrophobic vinylic monomers include methylacrylate, ethyl-acrylate, propylacrylate, isopropylacrylate, cyclohexylacrylate, 2-ethylhexylacrylate, methylmethacrylate, ethylmethacrylate, propylmethacrylate, vinyl acetate, vinyl propionate, vinyl butyrate, vinyl valerate, styrene, chloroprene, vinyl chloride, vinylidene chloride, acrylonitrile, I-butene, butadiene, methacrylonitrile, vinyl toluene, vinyl ethyl ether, perfluorohexylethyl-thio-carbonylaminoethylmethacrylate, isobornyl methacrylate, trifluoroethyl methacrylate, hexafluoro-isopropyl methacrylate, hexafluorobutyl methacrylate.

In at least some embodiments, any of the silicone-containing vinylic monomers, silicone-containing macromers, hydrophilic vinylic monomers, or hydrophobic vinylic monomers used in formulating the lens-forming material 110, may be used in formulating the pigmented ink used to print the pigmented layer 104 or the clear ink used to print the clear ink layer 106.

Examples of cross-linking agents that may be used in the SiHy lens formulation, the clear ink, or combinations thereof, include tetraethyleneglycol diacrylate, triethyleneglycol diacrylate, ethyleneglycol diacylate, diethyleneglycol diacrylate, tetraethyleneglycol dimethacrylate, triethyleneglycol dimethacrylate, ethyleneglycol dimethacylate, diethyleneglycol dimethacrylate, trimethylopropane trimethacrylate, pentaerythritol tetramethacrylate, bisphenol A dimethacrylate, vinyl methacrylate, ethylenediamine dimethyacrylamide, ethylenediamine diacrylamide, glycerol dimethacrylate, triallyl isocyanurate, triallyl cyanurate, allylmethacrylate, allylmethacrylate, 1,3-bis(methacrylamidopropyl)-1,1,3,3-tetrakis(trimethylsiloxy)disiloxane, N,N′methylenebisacrylamide, N,N′methylenebismethacrylamide, N,N′-ethylenebisacrylamide, N,N′-ethylenebismethacrylamide, 1,3-bis(N-methacrylamidopropyl)-1,1,3,3-tetrakis-(trimethylsiloxy)disiloxane, 1,3-bis(methacrylamidobutyl)-1,1,3,3-tetrakis(trimethylsiloxy)disiloxane, 1,3-bis(acrylamidopropyl)-1,1,3,3-tetrakis(trimethylsiloxy)disiloxane, 1,3-bis(methacryloxyethylureidopropyl)-1,1,3,3-tetrakis(trimethylsiloxy)disiloxane, and combinations thereof. An example cross-linking agent is tetra(ethyleneglycol)diacrylate, tri(ethyleneglycol)diacrylate, ethyleneglycol diacrylate, di(ethyleneglycol)diacrylate, methylenebisacrylamide, triallyl isocyanurate, or triallyl cyanurate. The amount of a crosslinking agent used is expressed in the weight content with respect to the total polymer and can be about 0.05% to about 4%, such as about 0.1% to about 2%.

Examples of suitable thermal initiators that may be used in the SiHy lens formulation, the clear ink, the pigmented ink or combinations thereof, include 2,2′-azobis(2,4-dimethylpentanenitrile), 2,2′-azobis(2-methylpropanenitrile), 2,2′-azobis(2-methylbutanenitrile), peroxides such as benzoyl peroxide, and the like. For example, the thermal initiator is 2,2′-azobis(isobutyronitrile) (AIBN).

Suitable photoinitiators that may be used in the SiHy lens formulation, the clear ink, the pigmented ink, or combinations thereof, are benzoin methyl ether, diethoxyacetophenone, a benzoylphosphine oxide, 1-hydroxycyclohexyl phenyl ketone and Darocur and Irgacur types, such as Darocur 1173® and Irgacur 2959®. Examples of benzoylphosphine initiators include 2,4,6-trimethylbenzoyldiphenylophosphine oxide; bis-(2,6-dichlorobenzoyl)-4-N-propylphenylphosphine oxide; and bis-(2,6-dichlorobenzoyl)-4-N-butylphenylphosphine oxide. Reactive photoinitiators, which can be incorporated, for example, into a macromer or can be used as a special monomer are also suitable. Examples of reactive photoinitiators are those disclosed in EP 632 329, herein incorporated by reference in its entirety. The polymerization can then be triggered by actinic radiation, for example light, in particular UV light of a suitable wavelength. The spectral requirements can be controlled accordingly, if appropriate, by addition of suitable photosensitizers.

Any suitable polymerizable UV-absorbing agents may be used. For example, a polymerizable UV-absorbing agent includes a benzotriazole-moiety or a benzophenone-moiety. Examples of polymerizable UV absorbers include 2-(2-hydroxy-5-vi-nylphenyl)-2H-benzotriazole, 2-(2-hydroxy-5-acrylyloxyphenyl)-2H-benzotriazole, 2-(2-hydroxy-3-methacrylamidomethyl-5-tertoctylphenyl)benzotriazole, 2-(2′hydroxy-5′-methacrylamidophenyl)-5-chlorobenzotriazole, 2-(2′-hydroxy-5′-methacrylamidophenyl)-5-methoxybenzotriazole, 2-(2′-hydroxy-5′-methacryloxypropyl-3′-t-butylphenyl)-5-chlorobenzotriazole, 2-(2′-hydroxy-5′-methacryloxyethylphenyl)benzotriazole, 2-(2′-hydroxy-5′methacryloxypropylphenyl)benzotriazole, 2-hydroxy-4-acryloxy alkoxy benzophenone, 2-hydroxy-4-methacryloxy alkoxy benzophenone, allyl-2-hydroxybenzophenone, 2-hydroxy-4-methacryloxy benzophenone.

The bioactive agent is any compound that can prevent a malady in the eye or reduce the symptoms of an eye malady. The bioactive agent can be a drug, an amino acid (e.g., taurine, glycine, etc.), a polypeptide, a protein, a nucleic acid, or any combination thereof. Examples of drugs useful herein include rebamipide, ketotifen, olaptidine, cromoglycolate, cyclosporine, nedocromil, levocabastine, lodoxamide, ketotifen, or the pharmaceutically acceptable salt or ester thereof. Other examples of bioactive agents include 2-pyrrolidone-5-carboxylic acid (PCA), alpha hydroxyl acids (e.g., glycolic, lactic, malic, tartaric, mandelic and citric acids and salts thereof, etc.), linoleic and gamma linoleic acids, and vitamins (e.g., B5, A, B6, etc.).

Examples of leachable lubricants include mucin-like materials (e.g., polyglycolic acid) and noncrosslinkable hydrophilic polymers (i.e., without ethylenically unsaturated groups). Any hydrophilic polymers or copolymers without any ethylenically unsaturated groups can be used as leachable lubricants. Examples of noncrosslinkable hydrophilic polymers include polyvinyl alcohols (PVAs), polyamides, polyimides, polylactone, a homopolymer of a vinyl lactam, a copolymer of at least one vinyl lactam in the presence or in the absence of one or more hydrophilic vinylic comonomers, a homopolymer of acrylamide or methacrylamide, a copolymer of acrylamide or methacrylamide with one or more hydrophilic vinylic monomers, polyethylene oxide (i.e., polyethyleneglycol (PEG)), a polyoxyethylene derivative, poly-N—N-dimethylacrylamide, polyacrylic acid, poly 2 ethyl oxazoline, heparin polysaccharides, polysaccharides, and mixtures thereof. The weight-average molecular weight M_{w} of the noncrosslinkable hydrophilic polymer can be 5,000 to 100,000.

Examples of leachable tear-stabilizing agents include phospholipids, monoglycerides, diglycerides, triglycerides, glycolipids, glyceroglycolipids, sphingolipids, sphingo-glycolipids, fatty alcohols, fatty acids, mineral oils, and mixtures thereof. For example, a tear stabilizing agent is a phospholipid, a monoglyceride, a diglyceride, a triglyceride, a glycolipid, a glyceroglycolipid, a sphingolipid, a sphingo-glycolipid, a fatty acid having 8 to 36 carbon atoms, a fatty alcohol having 8 to 36 carbon atoms, or a mixture thereof.

In accordance with the disclosure, a SiHy lens formulation, a clear ink, and a pigmented ink, can be a solution or a melt at a temperature of about 20° C. to about 85° C. For example, a polymerizable composition is a solution of all desirable components in a suitable solvent, or a mixture of suitable solvents.

A SiHy lens formulation, a clear ink, and a pigmented ink, can be prepared by dissolving all of the desirable components in any suitable solvent, such as, water, a mixture of water and one or more organic solvents miscible with water, an organic solvent, or a mixture of one or more organic solvents, as known to a person skilled in the art.

Examples of organic solvents include tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimethyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, N-methyl pyrrolidinone, and mixtures thereof.

Numerous SiHy lens formulations have been described in numerous patents and patent applications published by the filing date of this application. All of them can be used in obtaining the lens-forming material 110 which in turn becomes the lens body 311 of a SiHy contact lens 100 of the disclosure. In at least some embodiments, a SiHy lens formulation for making commercial SiHy lenses, such as, lotrafilcon A, lotrafilcon B, balafilcon A, galyfilcon A, senofilcon A, narafilcon A, narafilcon B, comfilcon A, enfilcon A, asmofilcon A, filcon II 3, may be used. In at least some embodiments, the clear ink layer 106 may include any of the listed components of the lens-forming material 110, so long as the resulting clear ink layer 106 includes about 38 wt % to about 70 wt % of a solid polymer.

### Methods

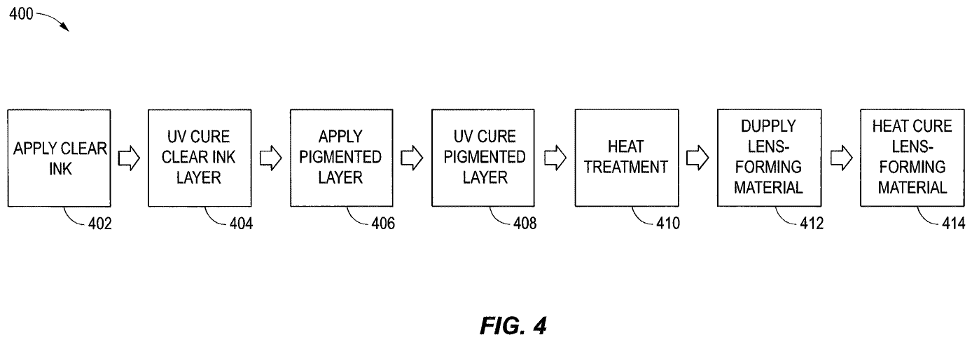

FIG. 4 is a flow diagram depicting a method 400 for forming a SiHy contact lens having a layered configuration, according to some embodiments. In operation 402, a clear ink (e.g., containing no pigment or dyes) is applied to at least an iris portion of a mold. In operation 404, the clear ink is cured with ultraviolet (UV) light to form a clear ink layer 106. In operation 406, at least one pigmented layer 104 is applied onto the clear ink layer 106, for example, via pad printing. In operation 408, the pigmented layer 104 is cured with UV light to form a lens assembly 310. In operation 410, the lens assembly 310 is heat treated. In operation 412, a lens forming material is supplied to the mold. In some embodiments, the lens forming material may be a silicon hydrogel macromer such as lotrafilconB. In operation 414, the lens forming material is heat cured forming the lens body 311.

In various embodiments, before performing operation 402 of method 400, the mold may be surface treated with a corona treatment, a plasma treatment, and/or a vacuum UV treatment to enhance the surface energies of the mold. In some embodiments, the surface treatment may enhance the clear ink layer 106 adhesion to the mold and prevent premature removal of the clear ink layer 106 during later printing processes.

The method 400 may be performed using any suitable polypropylene lens mold. Suitable lens molds may include those employed in cast molding or spin casting. For example, in at least one embodiment, a mold (for cast molding) includes at least two mold sections (or portions) or mold halves, i.e. first and second mold halves. The first mold half defines a first molding (or optical) surface and the second mold half defines a second molding (or optical) surface. The first and second mold halves are configured to receive each other such that a lens-forming cavity is formed between the first molding surface and the second molding surface. The molding surface of a mold half is the cavity-forming surface of the mold and is in direct contact with lens-forming material. In at least some embodiments, a mold having two mold halves is used during method 400. The first molding surface of the first mold half is a back curve used to mold the posterior surface 102 of the SiHy contact lens 100. The back curve of the first mold is a convex curve. The second molding surface of the second mold half is a front curve used to mold the anterior surface 101 of the SiHy contact lens 100. The front curve of the second mold is a concave curve.

In at least some embodiments, in operation 402, the clear ink which forms the clear ink layer 106 is pad printed onto the back curve of the first mold half. In some embodiments, the clear ink may be pad printed as an annular ring (or donut) around the pupil section of the mold to at least partially cover the iris section of the mold. In at least one embodiment, the clear ink is pad printed to cover the pupil section of the mold.

An example of pad printing follows. An image, such as an annular ring used in operation 402 or a pattern used in operation 406, is etched into metal to form a cliche. The cliche is placed in a printer. Once in the printer, the cliche is inked by either an open inkwell doctoring system or by a closed ink cup sliding across the image. Then, a silicone pad picks up the inked image from the cliche and transfers the image to the lens mold. The silicone pads include a material comprising silicone that can vary in elasticity. The properties of the silicone material permit the inks to stick to the pad temporarily and fully release from the pad when the pad contacts a contact lens or a mold. Appropriate pad-transfer printing structures include Tampotype printing structures (Tampa vario 90/130), rubber stamps, thimbles, doctor's blade, direct printing, or transfer printing as they are known in the art.

Any known suitable silicone pad can be used in the present disclosure. Silicone pads are commercially available. However, different pads could give different print qualities. A person skilled in the art will know how to select a pad for a given ink.

Cliche can include ceramics or metals (e.g., steel). In embodiments in which a cliche includes a steel, it would be desirable to neutralize the pH of a water-based ink (e.g., adjusted pH to 6.8-7.8) by adding a buffer (such as, for example, phosphate salts). Images can be etched into a cliche according to any methods known to a person skilled in the art, for example, by chemical etching or laser ablation or the like. It is also desirable to clean cliches after use using standard cleaning techniques known to a person skilled in the art, such as, for example, immersion in a solvent, sonication, or mechanical abrasion.

In at least some embodiments, the clear ink is cured to form the clear ink layer 106 in operation 404 with high intensity broad-spectrum UV light. The UV light may include UVA (315-400 nm), UVB (280-315 nm), UVC (100-280 nm), and UVV (395 nm to 455 nm). In at least some embodiments, the UV light has a spectral output of about 1,000 mW/cm² to about 3,000 mW/cm², such as about 1,200 mW/cm² to about 3,000 mW/cm², about 1,500 mW/cm² to about 3,000 mW/cm², about 2,000 mW/cm² to about 3,000 mW/cm², or about 2,500 mW/cm² to about 3,000 mW/cm². In at least one embodiment, the UV light is a UV fusion system. In at least some embodiments, the clear ink layer 106 may be cured with UV light for about 15 seconds to about 5 minutes at a temperature of about 20° C. to about 35° C. UV curing the clear ink layer 106 at operation 404 results in lenses having defined well-encapsulated pigmented layers 104.

In at least some embodiments, the clear ink layer 106 may include a solid polymer including about 38 wt % to about 70 wt % of polymer binder units and about 1 wt % to about 10 wt % of acid group containing units, about 0.05 wt % to about 4 wt % of a free-radical initiator, and a diluent or solvent. For example in at least some embodiments, the clear ink layer 106 includes a copolymer of a betacon macromer and DMA including about 20 wt % to about 30 wt % of betacon macromere units and about 20 wt % to about 30 wt % of DMA units, about 1 wt % to about 10 wt % of acrylic acid units, about 0.1 wt % to about 2 wt % of Irgacure 2959®, and a diluent or solvent.

In at least some embodiments, in operation 406, pigment-containing inks in the appropriate patterns are pad printed onto the cured clear ink layer 106 disposed on the back curve of the first mold half to form the pigmented layer 104. In some embodiments, a single pigmented layer 104 is pad printed on the cured clear ink layer 106. In other embodiments, a plurality of pigmented layers 104, each having a pattern, are pad printed on the cured clear ink layer 106.

In at least some embodiments the pigmented layer 104 is cured in operation 408 with high intensity broad-spectrum UV light. The UV light may include UVA, UVB, UVC, and UVV. In at least some embodiments. The UV light has a spectral output of about 1,000 mW/cm² to about 3,000 mW/cm², such as about 1,200 mW/cm² to about 3,000 mW/cm², about 1,500 mW/cm² to about 3,000 mW/cm², about 2,000 mW/cm² to about 3,000 mW/cm², or about 2,500 mW/cm² to about 3,000 mW/cm². In at least one embodiment, the UV light is a UV fusion system. In at least some embodiments, the pigmented layer 104 may be cured with UV light for about 15 seconds to about 5 minutes at a temperature of about 20° C. to about 35° C. In some embodiments, a plurality of pad printed pigmented layers 104 are cured at once. In other embodiments, each pigmented layer 104 of a plurality of pigmented layers 104 is individually cured before the next pigmented layer 104 is pad printed.

In at least some embodiments, the pigmented layer 104 may include 5 wt % to about 20 wt % of a pigment, about 30 wt % to about 40 wt % of polymer binder units, 1 wt % to about 4 wt % of a photoinitiator, and about 40 wt % to about 65 wt % of a diluent or solvent.

In at least some embodiments, heat treating the lens assembly 310 in operation 410 includes, placing the lens mold containing the lens assembly 310 in a curing oven under flowing nitrogen. The curing oven is purged with nitrogen gas for about 15 minutes to about 60 minutes, such as about 15 minutes to about 45 minutes, or about 15 minutes to about 30 minutes, at a temperature of about 20° C. to about 30° C., such as about 25° C. In at least some embodiments, the curing oven is purged to an oxygen level of about 0% to about 1% by volume, such as about 0.1% to about 0.9%, or about 0.5%. In at least some embodiments, the curing oven is purged to an oxygen level of about 0 ppm to about 2,000 ppm of oxygen, such as about 1 ppm to about 2,000 ppm, about 10 ppm to about 1,500 ppm, about 100 ppm to about 1,000 ppm, or about 1,000 ppm. The lens assembly is heated in the curing oven at a temperature of about 45° C. to about 65° C., such as about 55° C., for about 15 minutes to about 30 minutes for an intermediate temperature soak. In at least some embodiments, the lens assembly is further subjected to an elevated temperature soak after the intermediate temperature soak. The elevated temperature soak includes heating the lens assembly in the curing oven at a temperature of about 70° C. to about 90° C., such as about 80° C., for about 15 minutes to about 30 minutes. In at least some embodiments, the lens assembly is further subjected to a high temperature soak after the elevated temperature soak. The high temperature soak includes heating the lens assembly in the curing oven at a temperature of about 95° C. to about 110° C., such as about 100° C., for about 15 minutes to about 30 minutes. In at least some embodiments, one or more of the intermediate temperature soak, the elevated temperature soak, and the high temperature soak are performed under a constant nitrogen purge. Heat treating the lens assembly 310 at operation 410 prevents the pigments of the pigmented layers 104 from migrating into the lens-forming material 110 during operation 412, resulting in lenses having defined compact pigmented layers 104 and shaper patterns.

In at least some embodiments, in operation 412, the lens-forming material 110 is supplied to the front curve of the second mold half. The back curve of the first mold half, containing the heat treated lens assembly 310, is positioned on the front curve of the mold where it remains for subsequent heat curing. The back curve of the first mold half is positioned such that the lens-forming material 110 covers the heat treated lens assembly 310.

In at least some embodiments, heat curing the lens forming material in operation 414, includes, placing the lens mold containing the lens assembly 310 and the lens-forming material 110 in a curing oven under flowing nitrogen. The curing oven is purged with nitrogen gas for about 15 minutes to about 60 minutes, such as about 15 minutes to about 45 minutes, or about 15 minutes to about 30 minutes, at a temperature of about 20° C. to about 30° C., such as about 25° C. In at least some embodiments, the curing oven is purged to an oxygen level of about 0% to about 1% by volume, such as about 0.1% to about 0.9%, or about 0.5%. In at least some embodiments, the curing oven is purged to an oxygen level of about 0 ppm to about 2,000 ppm of oxygen, such as about 1 ppm to about 2,000 ppm, about 10 ppm to about 1,500 ppm, about 100 ppm to about 1,000 ppm, or about 1,000 ppm. The lens mold containing the lens assembly and the forming material is heated in the curing oven at a temperature of about 45° C. to about 65° C., such as about 55° C., for about 15 minutes to about 30 minutes for an intermediate temperature soak. In at least some embodiments, the lens mold is further subjected to an elevated temperature soak after the intermediate temperature soak. The elevated temperature soak includes heating the lens assembly in the curing oven at a temperature of about 70° C. to about 90° C., such as about 80° C., for about 15 minutes to about 30 minutes. In at least some embodiments, the lens mold is further subjected to a high temperature soak after the elevated temperature soak. The high temperature soak includes heating the lens assembly in the curing oven at a temperature of about 95° C. to about 110° C., such as about 100° C., for about 15 minutes to about 30 minutes. In at least some embodiments, one or more of the intermediate temperature soak, the elevated temperature soak, and the high temperature soak are performed under a constant nitrogen purge.

In at least some embodiments, after operation 414, back end processing including dry demolding and delensing is performed followed by in package coating/autoclave sterilization.

The above disclosure will enable one having ordinary skill in the art to practice embodiments. In order to better enable the reader to understand specific embodiments and the advantages thereof, the following examples are provided. The percentages in the formulations are based on weight percentages unless otherwise specified.

### EMBODIMENTS

The present disclosure is further directed to the following embodiments which may be combined with any embodiments described herein.

Clause 1. A method for forming a contact lens, comprising:
applying a clear ink to at least an iris portion of a mold, the clear ink comprising about 38 wt % to about 70 wt % of a polymer binder;
curing the clear ink with ultraviolet (UV) light to form a clear ink layer;
applying, via pad printing, at least one pigmented layer onto the clear ink layer; and
curing the at least one pigmented layer with ultraviolet (UV) light to form a lens assembly.
   Clause 2. The method of Clause 1, wherein the clear ink comprises an acid-group containing monomer.
   Clause 3. The method of Clauses 1 or 2, wherein the acid-group containing monomer comprises acrylic acid.
   Clause 4. The method of any of Clauses 1 to 4, wherein the clear ink comprises about 1 wt % to about 5 wt % of an acid-group containing monomer.
   Clause 5. The method of any of Clauses 1 to 4, wherein the UV light comprises UVA, UVB, UVC, and UVV light, and the UV light comprises a spectral output of about 1,000 mW/cm² to about 3,000 mW/cm².
   Clause 6. The method of any of Clauses 1 to 5, wherein the at least one pigmented layer comprises an iris pattern.
   Clause 7. The method of any of Clauses 1 to 6, further comprising:
placing the lens assembly in a curing oven while flowing nitrogen gas into the curing oven;
purging the curing oven at a temperature of about 20° C. to about 30° C. with nitrogen gas for about 15 minutes to about 60 minutes; and
heating the lens assembly in the curing oven at a temperature of about 45° C. to about 65° C. for about 15 minutes to about 30 minutes.
   Clause 8. The method of any of Clauses 1 to 7, further comprising:
heating the lens assembly in a curing oven at a temperature of about 70° C. to about 90° C. for about 15 minutes to about 30 minutes; and
heating the lens assembly in the curing oven at a temperature of about 95° C. to about 110° C. for about 15 minutes to about 30 minutes.
   Clause 9. The method of any of Clauses 1 to 8, further comprising pre-treating the mold with at least one of a corona treatment, a plasma treatment, and a vacuum ultraviolet (UV) light treatment before applying the clear ink layer.
   Clause 10. A method for forming a contact lens, comprising:
applying a clear ink to at least an iris portion of a mold;
curing the clear ink with ultraviolet (UV) light to form a clear ink layer;
applying, via pad printing, at least one pigmented layer onto the clear ink layer;
curing the at least one pigmented layer with UV light to form a lens assembly; and
heat treating the lens assembly.
   Clause 11. The method of Clause 10, further comprising:
supplying a lens-forming material into the mold, the lens-forming material covering the heat treated lens assembly; and
curing the lens-forming material.
   Clause 12. The method of Clauses 10 or 11, wherein the at least one pigmented layer is fully encapsulated.
   Clause 13. The method of any of Clauses 10 to 12, wherein the clear ink comprises acrylic acid.
   Clause 14. The method of any of Clauses 10 to 13, wherein the clear ink layer has a water contact angle of about 750 to about 120°.
   Clause 15. The method of any of Clauses 10 to 14, wherein the clear ink comprises a polymer binder comprising a silicone hydrogel macromer.
   Clause 16. The method of any of Clauses 10 to 15, wherein the clear ink comprises about 50 wt % to about 55 wt % of a polymer binder.
   Clause 17. The method of any of Clauses 1 to 16, further comprising pre-treating the mold with at least one of a corona treatment, a plasma treatment, a vacuum UV treatment, or combinations thereof.
   Clause 18. A contact lens, comprising:
a clear ink layer having a thickness of about 5 μm to about 20 μm and comprising about 38 wt % to about 70 wt % of polymer binder units and about 1 wt % to about 5 wt % of acid-group containing units, the clear ink layer forming an iris portion of the contact lens;
at least one pigmented layer disposed on the clear ink layer, the at least one pigmented layer comprising an iris pattern; and
a lens body disposed over the at least one pigmented layer, the lens body comprising a silicone hydrogel.
   Clause 19. The contact lens of Clause 18, wherein the at least one pigmented layer is fully encapsulated between the clear ink layer and the lens body.
   Clause 20. The contact lens of Clauses 18 or 19, wherein the clear ink layer has a water contact angle of about 75° to about 120°.

### EXAMPLES

### Example 1

### Effect of Clear Ink Layer Percent Polymer Binder

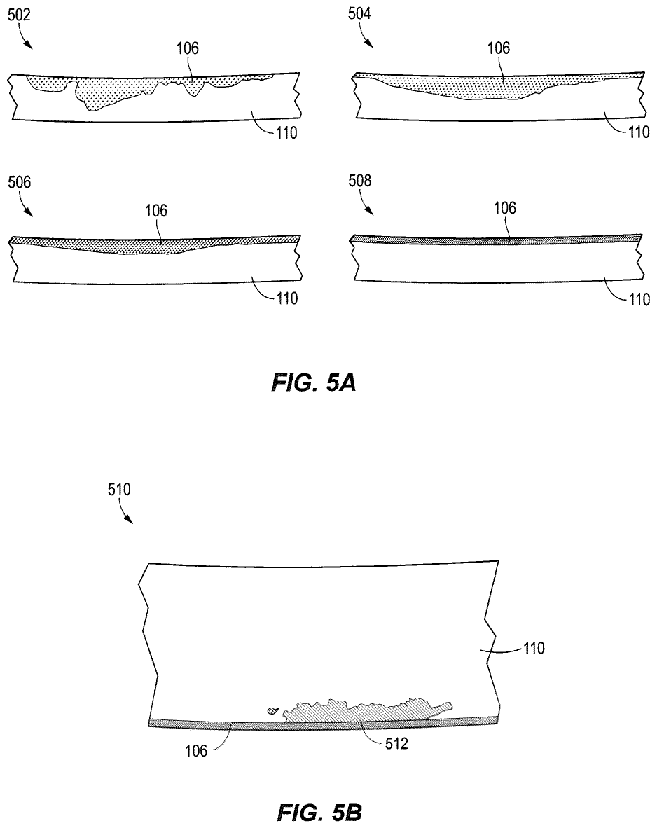

Clear inks having different polymer binder contents were prepared according to Table 1 and printed as described above. FIG. 5A depicts lenses formed using different polymer binder contents in the clear ink layer 106: lens 502 printed with ink-1 having about 38% polymer binder, lens 504 printed with ink-2 having about 50% polymer binder, lens 506 printed with ink-3 having about 55% polymer binder, and lens 508 printed with ink-4 having about 60% polymer binder. Phthalocyanine (PCN) blue was added to the clear ink (except ink-1) for better imaging in the optical micrographs. Higher percents of polymer binder resulted in less diffuse clear ink layers 106 as indicated by the penetration of PCN blue into the lens-forming material 110. For example, lens 504 printed with ink-2 having about 50% polymer binder had an uneven diffuse clear ink layer 106 having a thickness of about 12.8 μm to about 40.5 μm. In contrast, increasing the percent polymer binder by five percent resulted in a more defined clear ink layer 106 having a thickness of about 7.7 μm to about 15.3 μm, as shown in lens 506 printed with ink-3. Increasing the percent polymer binder to 60% used in ink-4 to print lens 508 resulted in a well-defined even clear ink layer 106 having a thickness of about 15 μm to about 15.9 μm.

TABLE 1

| | | | % Irgacure ® | | |
|---|---|---|---|---|---|
| | % polymer | % acrylic | 2959 | % PCN | |
| Ink | binder | acid | photoinitiator | blue | % diluent |
| Ink-1 | 38 | 3 | 1 | 0 | 58 |
| Ink-2 | 50 | 3 | 1 | ~0.01 | ~46 |
| Ink-3 | 55 | 3 | 1 | ~0.01 | ~41 |
| Ink-4 | 60 | 3 | 1 | ~0.01 | ~36 |

FIG. 5B depicts a 400× cross sectional image of lens 510, having a clear ink layer 106 printed using ink-3 and the methods describe herein. A black iron oxide limbal ring 512 printed on top of the clear ink layer 106 is fully encapsulated within the lens 510, having a 7.25 μm buffer between the pigment and the posterior surface 102.

### Example 2

Effect of UV curing the clear ink layer

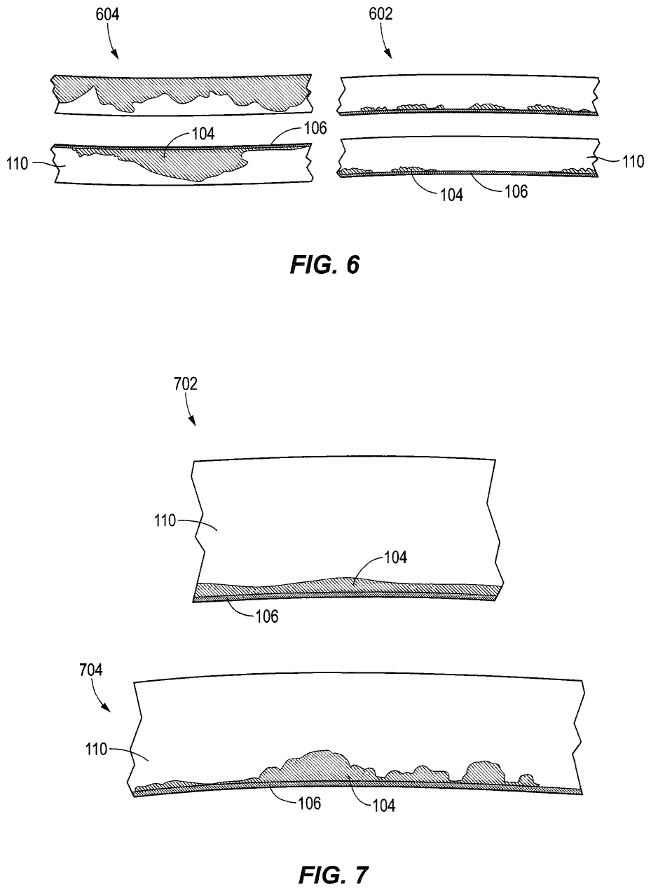

The method 400 disclosed herein includes operation 404, which includes UV curing the clear ink layer 106. FIG. 6 depicts lenses 602 printed with the UV cure of operation 404 and lenses 604 printed without the UV cure of operation 404 prior to printing the pigmented layer 104 onto the clear ink layer 106. UV curing the clear ink layer 106 at operation 404 results in lenses having defined well-encapsulated pigmented layers 104. For example, the lenses 604 printed without UV curing the clear ink layer 106 have diffuse clear ink layers 106 and pigmented layers 104 that extend into the lens-forming material 110. In contrast, the lenses 602 printed with the UV cure operation 404 prior to printing the pigmented layer 104 have well defined clear ink layers 106 and pigmented layers 104.

### Example 3

### Effect of Print Heat Treatment

The method 400 disclosed herein includes operation 410, which includes heat treating the lens assembly 310 prior to supplying the lens-forming material 110. FIG. 7 depicts lens 702 printed with a lens assembly 310 heat treatment and lens 704 printed without heat treating the lens assembly 310 prior to supplying the lens-forming material 110. Heat treating the lens assembly 310 at operation 410 results in lenses having defined compact pigmented layers 104. For example, while a discernable clear ink layer 106 can be seen in the non-heat treated lens 704, the pigmented layer 104 is diffuse and extends into the lens-forming material 110. In contrast, the heat treated lens 702 has a defined and compact pigmented layer 104.

### Example 4

### Wettability of the Clear Ink as a Function of Acrylic Acid

Clear inks having different acrylic acid contents were prepared according to Table 2, and the water contact angles of the UV cured lenses made from the clear inks were determined. A water contact angle on a contact lens is a general measure of the surface wettability of the contact lens. In particular, a low water contact angle corresponds to a more wettable surface. The water contact angle of the UV cured lenses was reduced with the addition of acrylic acid, indicating that wettability is achieved upon addition of acrylic acid in the formulation.

TABLE 2

| | % | % | % Irgacure ® | | Water |
|---|---|---|---|---|---|
| | polymer | acrylic | 2959 | | contact |
| Ink | binder | acid | photoinitiator | % diluent | angle |
| Ink-5 | 55 | 0 | 1 | 44 | 109 ± 8 |
| Ink-6 | 55 | 3 | 1 | 41 | 78 ± 2 |
| Ink-7 | 55 | 5 | 1 | 39 | 83.3 ± 3 |

Average contact angles (Sessile Drop) of contact lenses are measured using a VCA 2500 XE contact angle measurement device from AST, Inc., located in Boston, Mass. This equipment is capable of measuring advancing or receding contact angles or sessile (static) contact angles. The measurements are performed on fully hydrated contact lenses and immediately after blot-drying as follows. A contact lens is removed from the vial and washed 3 times in ˜200 ml of fresh DI water in order to remove loosely bound packaging additives from the lens surface. The lens is then placed on top of a lint-free clean cloth (Alpha Wipe TX1009), dabbed well to remove surface water, mounted on the contact angle measurement pedestal, blown dry with a blast of dry air and finally the sessile drop contact angle is automatically measured using the software provided by the manufacturer. The DI water used for measuring the contact angle has a resistivity>18 MΩcm and the droplet volume used is 2 μl. Typically, silicone hydrogel lenses (after autoclave) have a sessile drop contact angle around 120°. The tweezers and the pedestal are washed well with Isopropanol and rinsed with DI water before coming in contact with the contact lenses.

Overall, the present disclosure provides a silicon hydrogel (SiHy) contact lenses having a layered configuration that encapsulates (e.g., fully encapsulates) a layer of pigment, reducing wearer discomfort by reducing or preventing pigment abrasions on the inner eyelid, and methods for forming the same. In at least some embodiments, a clear ink layer includes a percent of solid polymer that, when cured using the methods disclosed herein, prevents a pigmented layer form diffusing into the clear ink layer, towards the eye, and into the body of the lens, away from the eye, resulting in a sharper (less diffuse) pattern. The complete encapsulation of the pigmented layer prevents pigment abrasions on the eye or inner eyelid, leading to a more comfortable SiHy contact lens. In at least some embodiments, the clear ink layer includes an acid group containing unit that increases the wettability of the clear ink layer, resulting in a more comfortable SiHy contact lens.

Although various embodiments of the disclosure have been described using specific terms, devices, and methods. Such description is for illustrative purposes only. The words used are words of description rather than of limitation. It is to be understood that changes and variations may be made by those skilled in the art without departing from the spirit or scope of the present disclosure, which is set forth in the following claims. In addition, it should be understood that aspects of the various embodiments may be interchanged either in whole or in part. Therefore, the spirit and scope of the appended claims should not be limited to the description of the preferred versions contained therein.

Some implementations and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Some lower limits, upper limits and ranges appear in one or more claims below.

What is claimed is:

1. A method for forming a contact lens, comprising:
applying a clear ink to at least an iris portion of a mold, the clear ink comprising about 38 wt % to about 70 wt % of a polymer binder;
curing the clear ink with ultraviolet (UV) light to form a clear ink layer;
applying, via pad printing, at least one pigmented layer onto the clear ink layer; and
curing the at least one pigmented layer with ultraviolet (UV) light to form a lens assembly.

2. The method of claim 1, wherein the clear ink comprises an acid-group containing monomer.

3. The method of claim 2, wherein the acid-group containing monomer comprises acrylic acid.

4. The method of claim 1, wherein the clear ink comprises about 1 wt % to about 5 wt % of an acid-group containing monomer.

5. The method of claim 1, wherein the UV light comprises UVA, UVB, UVC, and UVV light, and the UV light comprises a spectral output of about 1,000 mW/cm² to about 3,000 mW/cm².

6. The method of claim 1, wherein the at least one pigmented layer comprises an iris pattern.

7. The method of claim 1, further comprising:
placing the lens assembly in a curing oven while flowing nitrogen gas into the curing oven;
purging the curing oven at a temperature of about 20° C. to about 30° C. with nitrogen gas for about 15 minutes to about 60 minutes; and
heating the lens assembly in the curing oven at a temperature of about 45° C. to about 65° C. for about 15 minutes to about 30 minutes.

8. The method of claim 1, further comprising:
heating the lens assembly in a curing oven at a temperature of about 70° C. to about 90° C. for about 15 minutes to about 30 minutes; and
heating the lens assembly in the curing oven at a temperature of about 95° C. to about 110° C. for about 15 minutes to about 30 minutes.

9. The method of claim 1, further comprising pre-treating the mold with at least one of a corona treatment, a plasma treatment, and a vacuum ultraviolet (UV) light treatment before applying the clear ink layer.

10. A method for forming a contact lens, comprising:
applying a clear ink to at least an iris portion of a mold;
curing the clear ink with ultraviolet (UV) light to form a clear ink layer;
applying, via pad printing, at least one pigmented layer onto the clear ink layer;
curing the at least one pigmented layer with UV light to form a lens assembly; and
heat treating the lens assembly.

11. The method of claim 10, further comprising:
supplying a lens-forming material into the mold, the lens-forming material covering the heat treated lens assembly; and
curing the lens-forming material.

12. The method of claim 11, wherein the at least one pigmented layer is fully encapsulated.

13. The method of claim 10, wherein the clear ink comprises acrylic acid.

14. The method of claim 10, wherein the clear ink layer has a water contact angle of about 750 to about 120°.

15. The method of claim 10, wherein the clear ink comprises a polymer binder comprising a silicone hydrogel macromer.

16. The method of claim 10, wherein the clear ink comprises about 50 wt % to about 55 wt % of a polymer binder.

17. The method of claim 10, further comprising pre-treating the mold with at least one of a corona treatment, a plasma treatment, a vacuum UV treatment, or combinations thereof.

18. A contact lens, comprising:
a clear ink layer having a thickness of about 5 μm to about 20 μm and comprising about 38 wt % to about 70 wt % of polymer binder units and about 1 wt % to about 5 wt % of acid-group containing units, the clear ink layer forming an iris portion of the contact lens;
at least one pigmented layer disposed on the clear ink layer, the at least one pigmented layer comprising an iris pattern; and
a lens body disposed over the at least one pigmented layer, the lens body comprising a silicone hydrogel.

19. The contact lens of claim 18, wherein the at least one pigmented layer is fully encapsulated between the clear ink layer and the lens body.

20. The contact lens of claim 18, wherein the clear ink layer has a water contact angle of about 750 to about 120°.
